(19) United States
(12) Patent Application Publication
(10) Pub. No.: US 2004/0080881 A1
(43) Pub. Date: Apr. 29, 2004

(54) Integrated circuit with electrostatic discharge protection

(76) Inventor: Ya-Wei Chou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/370,500

(22) Filed: Feb. 24, 2003

(30) Foreign Application Priority Data
Oct. 25, 2002 (TW) 091124949

(51) Int. Cl. H02H 9/00

(52) U.S. Cl. 361/56

(57) ABSTRACT

An integrated circuit with electrostatic discharge (ESD) protection is disclosed. The integrated circuit with electrostatic discharge protection comprises an inductor and a capacitor which can cancel the reactance induced by electrostatic discharge protection elements at an operating radio frequency. By choosing the combination of ESD protection elements, the inductor and the capacitor with proper equivalent reactance values, the mismatch caused by ESD protection elements can be eliminated at an operating radio frequency.

### BACKGROUND OF THE INVENTION

1. Field of the Invention

The present invention relates to an integrated circuit with electrostatic discharge protection, and more particularly to an integrated circuit with electrostatic discharge protection without impedance mismatch.

2. Description of the Related Art

Integrated circuits are susceptible to damage when they are subjected to electrostatic discharge (ESD), more commonly known as “static electricity”. While the discharge of static electricity can be a “shocking” experience for humans, the effect is usually fleeting. However, the effect on an IC can be permanent. The energy from the discharge of static electricity can be enough to vaporize conductor paths in an IC, causing the IC to be completely inoperable, to function in an unpredictable way, or to create defects which shorten the life of the IC. ESD events can occur at any time during the life of the part but most events that cause damage occurs between the time that the circuit is manufactured in wafer form and the time that the circuit is physically mounted in the circuit board that connects the integrated circuit into the system where it is to be used.

ICs are usually protected from ESD damage by including extra device structures that are designed to absorb the ESD events while not causing an undesired effect on the performance of the circuit. These structures can be as simple as a fuse or diode, or more complicated, such as grounded n-type metal oxide semiconductor (NMOS) transistors or bipolar transistors in latch back configuration. For high performance, high frequency applications, the capacitance of the ESD protection circuitry can be the limiting factor on the performance of the circuit.

FIG. 1 shows a conventional ESD protection circuit for a radio frequency (RF) circuit. ESD diodes 106 and 108 are respectively connected to Vcc power and to Vss ground. The ESD diodes 106 and 108 are coupled between an input/output pad 102 and a radio frequency circuit 104. The conventional ESD protection circuit can provide an ESD path to discharge a large ESD current. These ESD diodes are all designed to have a large dimension in order to discharge large ESD current and the larger dimension the ESD diodes have, the better ESD performance the ESD diodes can provide. However, large dimension of the ESD diodes also generates unavoidable side effect of large loading capacitance which would induce severe impedance mismatch especially on high frequency operation. Moreover, the excess capacitance would also degrade the signal level for high frequency RF pad. In order to reduce the undesired capacitance loading which would degrade the electrical performance of a RF circuit, dimension decrease of ESD diodes is used to minimize the capacitance loading. Nevertheless, dimension minimization of ESD diodes would also degrade the protection performance of the ESD diodes. Therefore, it is the dilemma of increasing ESD diode dimension to enhance ESD protection but also increasing capacitance loading or decreasing ESD diode dimension to reduce capacitance loading but also degrading ESD protection performance.

In view of the drawbacks mentioned with the prior art ESD circuit, there is a continued need to develop new and improved ESD protection circuit that overcome the disadvantages associated with the prior art ESD circuit.

### SUMMARY OF THE INVENTION

It is therefore an object of the invention to provide an ESD protection circuit that can eliminate undesired capacitance induced by the dimension increase of ESD devices and lead to a perfect zero reactance ESD protection part.

It is another object of this invention to provide a ESD protection circuit that can solve the dilemma of increasing ESD device dimension to enhance ESD protection but also increasing capacitance loading or decreasing ESD device dimension to reduce capacitance loading but also degrading ESD protection performance.

It is a further object of this invention to provide an ESD protection circuit that is especially useful for a high frequency circuit.

To achieve these objects, and in accordance with the purpose of the invention, the invention uses an integrated circuit with electrostatic discharge protection, the integrated circuit comprises a first power supply line and a second power supply line, a first electrostatic discharge protection device and a second electrostatic discharge protection device coupled in series between said first power supply line and said second power supply line, an inductor coupled between a first node between an input/output pad and a radio frequency circuit and a second node between said first and second electrostatic discharge protection devices, and a capacitor coupled between said first node and said second power supply line.

In another embodiment of this invention, the integrated circuit comprises a first power supply line and a second power supply line, a first electrostatic discharge protection device coupled between said first power supply line and a first node between an input/output pad and a radio frequency circuit and an inductor and a second electrostatic discharge protection device coupled in series between said first node and said second power supply line.

It is to be understood that both the foregoing general description and the following detailed description are exemplary and explanatory only and are not restrictive of the invention, as claimed.

### BRIEF DESCRIPTION OF THE DRAWINGS

The objects, features and advantages of the apparatus for the present invention will be apparent from the following description in which:

FIG. 1 shows a conventional ESD protection circuit for a radio frequency (RF) circuit;

FIG. 2A shows one embodiment of an ESD protection circuit according to the invention;

FIG. 2B shows another embodiment of ESD protection circuits according to the invention;

FIG. 2C shows an equivalent circuit of the circuits separately shown in FIGS. 2A and 2B;

FIG. 3A shows an ESD protection element;

FIG. 3B shows an ESD protection element;

FIG. 3C shows an ESD protection element;

FIG. 3D shows an ESD protection element;

FIG. 4A shows a simulation result of the circuit shown in FIG. 2C; and

FIG. 4B shows a simulation result of the equivalent reactance of the inductor and the equivalent capacitors of the circuit shown in FIG. 2C.

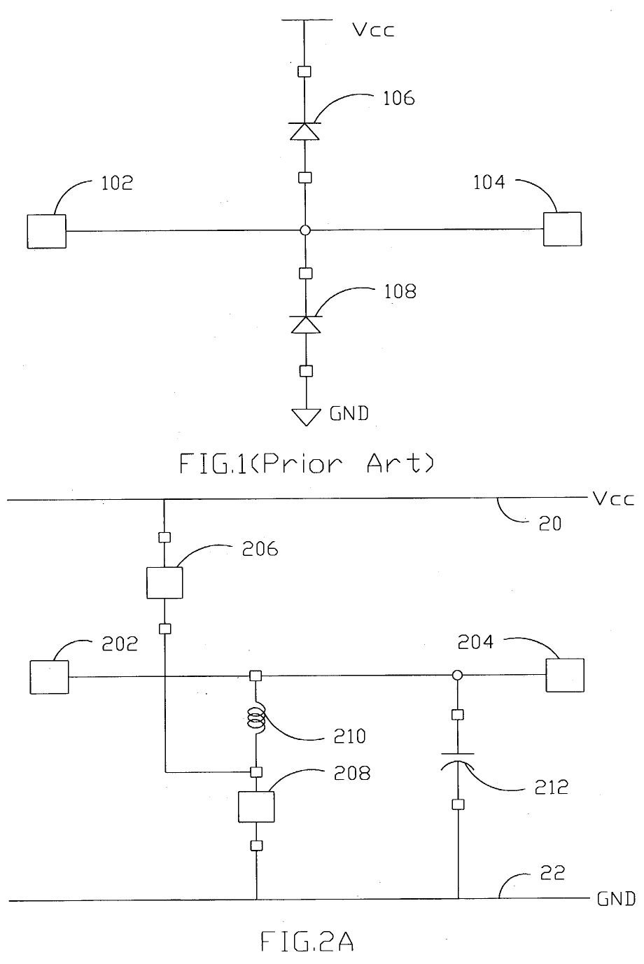

### DESCRIPTION OF THE PREFERRED EMBODIMENT

It is to be understood and appreciated that the circuit described below do not form a complete RF circuit. The present invention can be practiced in conjunction with various circuit fabrication techniques that are used in the art, and only so much of the commonly practiced components are included herein as are necessary to provide an understanding of the present invention.

The present invention will be described in detail with reference to the accompanying drawings. It should be noted that the drawings are in greatly simplified form and they are not drawn to scale. Moreover, dimensions have been exaggerated in order to provide a clear illustration and understanding of the present invention.

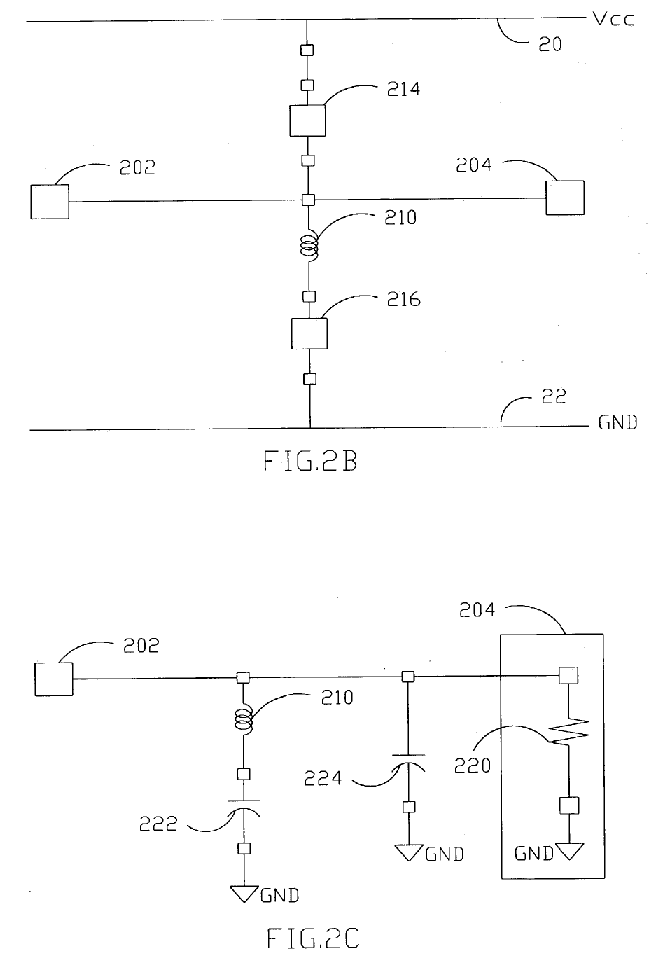

FIG. 2A shows one embodiment of ESD protection circuits according to the invention. The ESD protection circuits are coupled between power supply lines 20 and 22 to protect a RF circuit 204 against damage from electrostatic discharge. The power supply line 20 may be provided with a voltage Vcc and the power supply line 22 is coupled to ground potential (GND), for example. An input/output (I/O) pad 202 which serves to receive input signals, provide output signals generated within the RF circuit 204 is coupled to the RF circuit 204. FIG. 2A also shows ESD protection elements 206 and 208 coupled in series between the power supply lines 20 and 22. An inductor 210 is coupled between a node between the I/O pad 202 and the RF circuit 204 and a node between the ESD protection elements 206 and 208. A capacitor 212 is coupled between a node between the I/O pad 202 and the RF circuit 204 and the power supply line 22. The capacitor 212 is just an example and it can be replaced with other circuit devices such as MOS capacitors.

FIG. 2B shows another embodiment of ESD protection circuits according to the invention. The ESD protection circuits are coupled between power supply lines 20 and 22 to protect the RF circuit 204 against damage from electrostatic discharge. FIG. 2B shows an ESD protection element 214, the inductor 210 and an ESD protection element 216 coupled in series between the power supply lines 20 and 22. The ESD protection element 214 is coupled between the power supply line 20 and the node between the I/O pad 202 and the RF circuit 204. The inductor 210 and the ESD protection element 216 are coupled in series between the node between the I/O pad 202 and the RF circuit 204 and the power supply line 22. The power supply line 20 may be provided with a voltage Vcc and the power supply line 22 is coupled to ground potential (GND), for example.

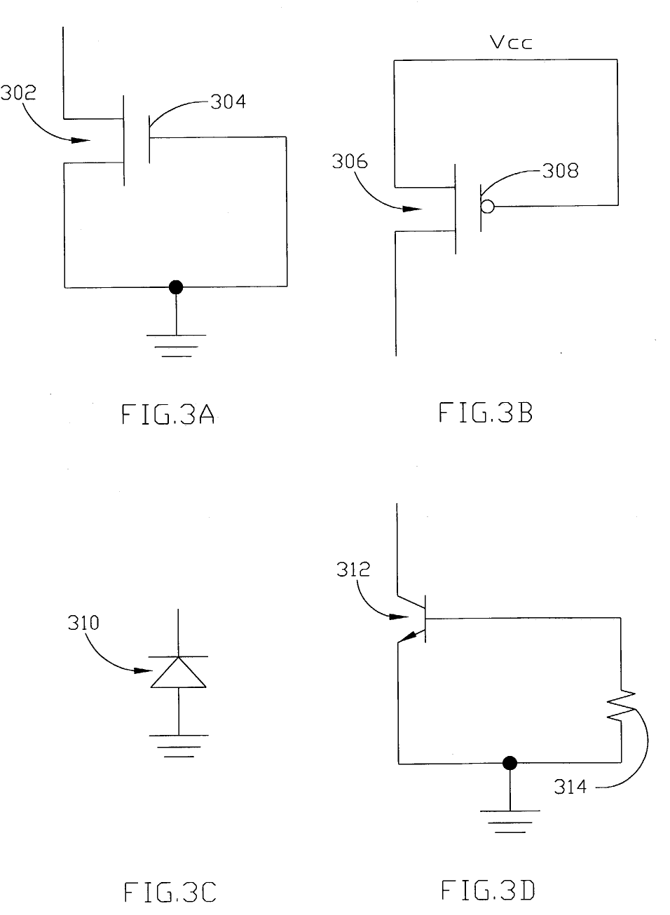

The RF circuit 204 can be, for example a transceiver for a cellular mobile handset. Generally, ESD protection circuits appear as an open circuit in normal circuit function, and act as a discharge path only in ESD events. The ESD protection elements 206, 208, 214 and 216 comprise circuit elements which can be normally used for ESD protection. Examples of these circuit elements are an NMOS transistor 302 with a grounded gate 304, an inactive PMOS transistor 306 with a gate 308 coupled at the same potential as the drain (in this case Vcc), a diode 310, and a latch back NPN bipolar transistor 312 with a resistor 314 coupled from the base to the emitter of the transistor as shown in FIG. 3A to FIG. 3D, respectively.

The diode 310 of FIG. 3C can be used as ESD protection elements 206, 208, 214 and 216 in FIGS. 2A and 2B. Diodes acting as ESD protection elements 206, 208, 214 and 216 function as follows. If an ESD event occurs at the I/O pad 202 which is negative relative to the power supply line 22(GND), it is discharged through ESD protection diode 208 in FIG. 2A or ESD protection element 216 in FIG. 2B. If the potential of an ESD event is positive relative to the power supply line 22(GND), it is discharged through ESD protection diode 206 in FIG. 2A or ESD protection diode 214 in FIG. 2B, through a circuit back to ground. Otherwise, if the potential of an ESD event at the I/O pad 202 is positive relative to the power supply line 20 (Vcc), it is discharged through a forward biased diode 206 in FIG. 2A or a forward biased diode 214 in FIG. 2B to the power supply line 20 (Vcc). If negative relative to the power supply line 20 (Vcc), the ESD event is discharged through ESD protection diode 208 in FIG. 2A or ESD protection diode 216 in FIG. 2B.

The grounded gate NMOS 302 of FIG. 3A is often used for ESD protection elements 208 and 216 in conjunction with the use of the diode 310 of FIG. 3C or the inactive PMOS device 306 of FIG. 3B for the ESD protection elements 206 and 214. The grounded gate NMOS 302 will go into a known “snap back” mode, allowing an ESD event to discharge from the I/O pad 202 to the power supply line 22. Similarly, an inactive PMOS device used for ESD protection elements 206 and 214 will breakdown to carry the ESD event. The latch back NPN bipolar transistor of FIG. 3D is often used for ESD protection elements 208 and 216 usually with the diode 310 of FIG. 3C for ESD protection elements 206 and 214.

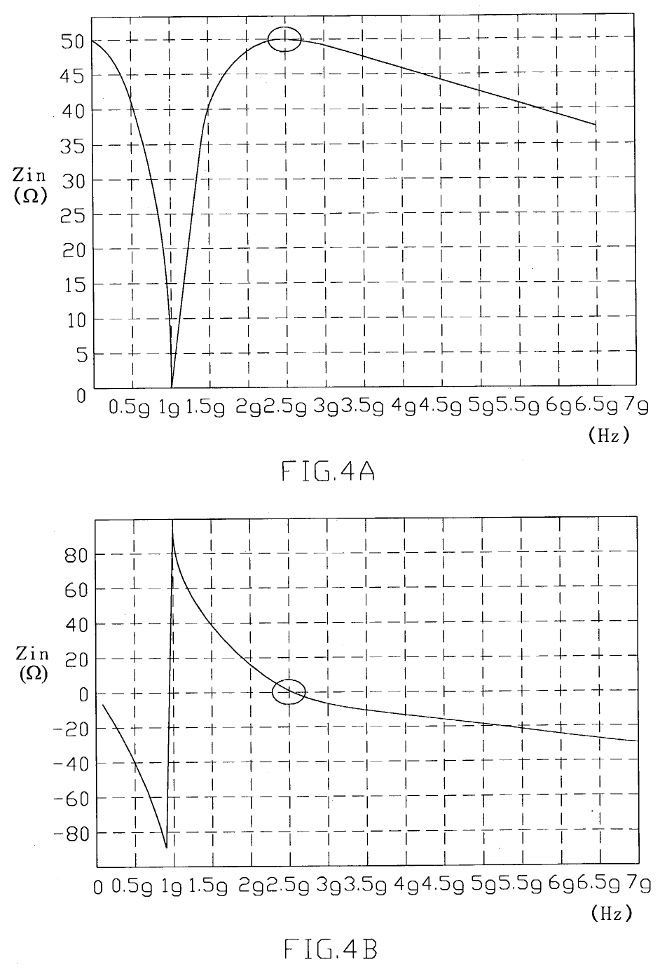

FIG. 2C shows an equivalent circuit of the circuits separately shown in FIGS. 2A and 2B under an alternating current (AC) mode. The equivalent reactance of the ESD protection circuits shown in FIGS. 2A and 2B and the equivalent thereof which exclude the I/O pad 202 and the RF circuit 204 could achieve zero under a certain RF frequency and by choosing the combination of ESD protection elements and inductor with proper equivalent reactance values. The addition of the inductor 210 and the capacitor 212 cancels or compensates the reactance induced by the ESD protection elements 206 and 208. The addition of the inductor 210 cancels or compensates the reactance induced by the ESD protection elements 214 and 216. By simulation under an AC mode, the simulation results of the circuit shown in FIG. 2C are shown in FIGS. 4A and 4B. The reactance value of an equivalent reactance loading 220 of the RF circuit 204 is 50 Ohms. FIG. 4A shows how the total reactance of the circuit shown in FIG. 2C varies with the operating frequency. The total reactance of the circuit shown in FIG. 2C achieves 50 Ohms which equals to the equivalent reactance loading 220 of the RF circuit 204 at a operating frequency of 2.5 GHz. At the operating frequency of 2.5 GHz, the equivalent reactance of the inductor 210, the equivalent capacitors 222 and 224 achieves 0. FIG. 4B further shows how the equivalent reactance of the inductor 210, the equivalent capacitors 222 and 224 varies with the operating frequency. The equivalent reactance of the inductor 210, the equivalent capacitors 222 and 224 achieve 0 at 2.5 GHz which means that the impedance mismatch induced by the ESD protection elements is compensated and cancelled. The operating frequency is preferably in a range between about 900 MHz to about 10 GHz.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claim is:

1. An integrated circuit with electrostatic discharge protection, said integrated circuit comprising:
a first power supply line and a second power supply line;
a first electrostatic discharge protection device and a second electrostatic discharge protection device coupled in series between said first power supply line and said second power supply line;
an inductor coupled between a first node between an input/output pad and a radio frequency circuit, and a second node between said first and second electrostatic discharge protection devices;
and a capacitor coupled between said first node and said second power supply line.

2. The integrated circuit of claim 1, wherein said first power supply line is coupled to a voltage Vcc.

3. The integrated circuit of claim 1, wherein said second power supply line is coupled to ground.

4. The integrated circuit of claim 1, wherein said first and said second electrostatic discharge protection devices comprises diodes.

5. The integrated circuit of claim 1, wherein said first electrostatic discharge protection device comprises a P-type metal oxide semiconductor transistor with a gate coupled and a drain coupled to said first power supply line.

6. The integrated circuit of claim 1, wherein said second electrostatic discharge protection device comprises an N-type metal oxide semiconductor transistor with a grounded gate.

7. The integrated circuit of claim 1, wherein said second electrostatic discharge protection device comprises a latch back NPN bipolar transistor with a resistor coupled from a base to an emitter of said bipolar transistor.

8. The integrated circuit of claim 1, wherein the radio frequency circuit is operated at a range of about 900 MHz to about 10 GHz.

9. An integrated circuit with electrostatic discharge protection, said integrated circuit comprising:
a first power supply line and a second power supply line;
a first electrostatic discharge protection device coupled between said first power supply line and a first node between an input/output pad and a radio frequency circuit; and
an inductor and a second electrostatic discharge protection device coupled in series between said first node and said second power supply line.

10. The integrated circuit of claim 9, wherein said first power supply line is coupled to a voltage Vcc.

11. The integrated circuit of claim 9, wherein said second power supply line is coupled to ground.

12. The integrated circuit of claim 9, wherein said first and said second electrostatic discharge protection devices comprises diodes.

13. The integrated circuit of claim 9, wherein said first electrostatic discharge protection device comprises a P-type metal oxide semiconductor transistor with a gate coupled and a drain coupled to said first power supply line.

14. The integrated circuit of claim 9, wherein said second electrostatic discharge protection device comprises an N-type metal oxide semiconductor transistor with a grounded gate.

15. The integrated circuit of claim 9, wherein said second electrostatic discharge protection device comprises a latch back NPN bipolar transistor with a resistor coupled from a base to an emitter of said bipolar transistor.

16. The integrated circuit of claim 9, wherein the radio frequency circuit is operated at a range of about 900 MHz to about 10 GHz.
